(19) United States
(12) Patent Application Publication
(10) Pub. No.: US 2026/0326934 A1
(43) Pub. Date: Oct. 22, 2026

(54) System and method for mobility of a portable electronic device using reversible wheel-propeller assemblies

(71) Applicant: Adam Melhem, Kafr Yassif (IL)

(72) Inventor: Adam Melhem, Kafr Yassif (IL)

(21) Appl. No.: 19/687,150

(22) Filed: May 26, 2026

Related U.S. Application Data
(60) Provisional application No. 63/909,688, filed on Oct. 31, 2025.

(51) Int. Cl. B64U 10/70; B64D 31/16; B64U 30/26; B64U 30/293

(52) U.S. Cl. CPC B64U 10/70; B64U 30/26; B64U 30/293; B64D 31/16

(57) ABSTRACT

A system and method for mobility of a portable electronic device using reversible wheel-propeller assemblies is disclosed. The system includes a device having a control unit coupled to a communication interface configured to receive user input or external control data and generate control signals. The communication interface transmits command data to actuate coupled components. A plurality of propellers driven by motors disposed within a device housing generate thrust to produce lift and traction. Electronic speed controllers regulate motor speed and direction based on the control signals. A detachable case includes a wireless communication receiver configured to receive command data via electromagnetic coupling with a transmitter of device and generate motor control outputs. Visual indicators display operational states. Attachment assemblies include wheel-propeller structures with internal blades enabling aerial and surface mobility. A movable arm structure displaces the wheel propeller structure, and a power and data interface delivers power and coordinated control.

### FIELD OF INVENTION

Embodiments of the present disclosure relate to the field of device mobility systems adapted to integrate aerial propulsion and ground locomotion mechanism and more particularly a system and method for mobility of a portable electronic device using reversible wheel-propeller assemblies.

### BACKGROUND

Portable electronic devices including smartphones have evolved to incorporate advanced processors, high-resolution cameras, inertial sensors, and multiple wireless communication interfaces, thereby enabling their use in applications associated with unmanned aerial vehicles and drone ecosystems. These devices are commonly utilized as at least one of a control terminal, an imaging unit, and communication node for aerial platforms along with supporting functions such as navigation assistance, real-time video streaming, and remote command transmission. The increasing computational capability and sensor integration within such devices have positioned them as key components in modern aerial operation environment.

The existing systems and technologies for unmanned aerial operation generally rely on dedicated drone hardware platforms that include independent propulsion systems, flight controllers, and embedded communication modules. In such arrangements, the portable electronic devices are adapted to function as an external controller that transmit commands to the drone through wireless protocols and receive telemetry or visual data in return. The flight stability, propulsion control, and actuation are managed by onboard electronics within the drone, while the portable device provides user interface functionalities and high-level control inputs. Some systems incorporate mounting mechanisms to physically attach the device to the drone for imaging or monitoring purposes, without integrating core propulsion functionalities.

However, such existing approaches exhibit several limitations due to their dependence on separate and discrete hardware components. The requirement of an independent drone platform increases overall system cost, bulk, and maintenance effort, limiting accessibility for general users. Additionally, the separation between the portable device and propulsion hardware leads to inefficiencies in communication, including latency and reduced synchronization between control inputs and actuation responses. The inability to directly utilize the internal processing and sensing capabilities of the portable electronic device for propulsion-related operations further restricts the system optimization and responsiveness.

Furthermore, conventional technologies lack flexibility in extending device functionality beyond a predefined aerial operations. The absence of an integrated and a modular mechanism for enabling alternative mobility modes, such as ground-based movement, limits the adaptability of such systems. Moreover, the existing solutions also do not adequately address seamless hardware-software interaction within a unified framework, thereby resulting in an underutilization of available computational resources. These technical gaps highlight constraints in achieving a compact, versatile, and functionally integrated mobility solution within current device-centric aerial system.

Hence, there is a need for an improved a system and method for mobility of a portable electronic device using reversible wheel-propeller assemblies which addresses the aforementioned issue(s).

### OBJECTIVES OF THE INVENTION

The primary objective of the invention is to provide an integrated mobility system for a computing device by incorporating a plurality of motor-driven propellers directly within or attachable to the device structure. The system enables a controlled thrust generation via electronic speed controllers interfaced with a processor. The configuration facilitates a coordinated propulsion control using embedded hardware and software interaction. The objective further includes enabling aerial functionality without altering the core device architecture.

Another objective of the invention is to provide a detachable case and attachment assemblies incorporating propulsion components, communication interfaces, and power mechanisms. The system enables transmission of control commands through near-field communication and optionally supports wireless power transfer for motor actuation. The detachable structure further includes a plurality of visual indicators configured to represent operational states.

Yet another objective of the invention is to provide a hybrid mobility using wheel-propeller assemblies configured for dual-mode operation. The system enables a generation of lift or traction through reversible motor rotation controlling airflow direction. The assemblies further include movable arm structures adapted to transition between a raised aerial position and a ground-contact position.

Yet another objective of the invention is to provide a multi-device control architecture integrating primary and secondary control interfaces. The control signals are transmitted through wireless communication protocols and relayed to a propulsion component through a coordinated communication loop. This enables a simultaneous control input for optimized operational flexibility.

Yet another objective of the invention is to provide a synchronized control and feedback system enabling real-time interaction between multiple devices and propulsion units. The system enables a transmission of a telemetry, video data, and haptic feedback across connected interfaces. The configuration supports remote operation, live monitoring, and auxiliary control functions through distributed communication channels. The system optimizes responsiveness and coordination in complex operational environments.

### SUMMARY

In accordance with an embodiment of the present disclosure, a system for mobility of a portable electronic device using reversible wheel-propeller assemblies is disclosed. The system includes the portable electronic device including a control unit operatively coupled to a communication interface, wherein the control unit is configured to receive at least one of a user input and an external control data to generate a plurality of control signals. Additionally, the communication interface is configured to transmit the plurality of control signals in a form of a command data to actuate at least one or more operatively coupled components. The system includes a plurality of propellers integrated with the portable electronic device, wherein each of the plurality of propellers is adapted to rotationally actuate by a plurality of motors, wherein each of the plurality of motors is being disposed within a housing of the portable electronic device. Additionally, the plurality of propellers is adapted to generate a thrust upon controlled rotation, wherein the controlled rotation is being imparted by a corresponding motor to produce at least one of a lift and traction controlled rotation of the portable electronic device. The system includes a plurality of electronic speed controllers operatively coupled the plurality of motors, wherein each of the electronic speed controllers is configured to regulate at least one of a rotational speed and rotational direction of the corresponding motor in response to the control signals received from the portable electronic device. The system includes a detachable case releasably secured to the portable electronic device, and a wireless communication receiver operatively coupled to the motor, wherein, the wireless communication receiver is configured to receive a command data via an electromagnetic coupling with a wireless communication transmitter of the portable electronic device. Additionally, the wireless communication receiver is configured to generate a motor control signal by processing a received command data and derive a control output for actuation of the motor. The system includes a plurality of visual indicators disposed on the detachable case and electrically coupled with the near-field communication receiver, wherein each of the visual indicator is configured to receive the motor control signals from the near-field communication receiver. Additionally, each of the visual indicator is configured to indicate an operational state of the system via a corresponding visual output, wherein the operational state comprises at least one of a flight initiation, landing indication, and power status. The system includes a plurality of attachment assemblies including a motor-driven wheel-propeller structure, wherein the wheel-propeller structure comprises a wheel body and an internal propeller blade assembly disposed within the wheel body, wherein the motor is adapted to rotate the internal propeller blade assembly in a first rotational direction to generate an airflow producing lift for an aerial movement and in a second rotational direction to generate a contact force for traction, thereby enabling a surface mobility of the portable electronic device. The system includes a movable arm structure coupled to the plurality of attachment assemblies, wherein the movable arm structure is adapted to displace the wheel-propeller structure to at least one of a raised position and a lowered ground-contact position in response to a rotation of the motor.

In accordance with an embodiment of the present disclosure, a method for mobility of a portable electronic device using reversible wheel-propeller assemblies is disclosed. The method includes receiving, by a control unit, at least one of a user input and an external control data and generate a plurality of control signals, wherein a portable electronic device comprises the control unit. The method includes transmitting, by a communication interface, the plurality of control signals in a form of a command data to actuate at least one or more operatively coupled components, wherein the control unit is operatively coupled to the communication interface. The method includes actuating rotationally, by a plurality of motors, a plurality of propellers, wherein each motor is being disposed within a housing of the portable electronic device. The method includes generating, by the plurality of motors, a thrust by rotating the plurality of propellers under controlled operation, wherein the rotation of the plurality of propellers produces at least one of a lift and a traction for controlled movement of the portable electronic device. The method includes regulating, by a plurality of electronic speed controllers, at least one of a rotational speed and rotational direction of the corresponding motor in response to the control signals received from the portable electronic device. The method includes receiving, by a near-field communication receiver, a command data via an electromagnetic coupling with a wireless communication transmitter of the portable electronic device. The method includes generating, by processing a received command data, a motor control signal and derive a control output for actuation of the motor. The method includes receiving, by a plurality of visual indicators, the motor control signals from the near-field communication receiver. The method includes indicating, via a corresponding visual output, an operational state of the system, wherein the operational state comprises at least one of a flight initiation, landing indication, and power status. The method includes rotating, by the motor, an internal propeller blade assembly in a first rotational direction to generate an airflow producing lift for an aerial movement and in a second rotational direction to generate a contact force for traction, thereby enabling a surface mobility of the portable electronic device. The method includes displacing, by a movable arm structure, a wheel-propeller structure to at least one of a raised position and a lowered ground-contact position in response to a rotation of the motor, wherein the movable arm structure is coupled to a plurality of attachment assemblies.

In accordance with an embodiment of the present disclosure, a non-transitory computer-readable medium storing a computer program that, when executed by a processor, causes the processor to perform a method for mobility of a portable electronic device using reversible wheel-propeller assemblies is disclosed. The system includes receiving at least one of a user input and an external control data and generate a plurality of control signals. The system includes transmitting the plurality of control signals in a form of a command data to actuate at least one or more operatively coupled components. The system includes regulating at least one of a rotational speed and rotational direction of the corresponding motor in response to the control signals received from a portable electronic device. The system includes receiving a command data via an electromagnetic coupling with a wireless communication transmitter of the portable electronic device. The system includes generating a motor control signal and derive a control output for actuation of the motor. The system includes receiving the motor control signals from a near-field communication receiver. The system includes indicating an operational state of the system, wherein the operational state comprises at least one of a flight initiation, landing indication, and power status. The system includes delivering an electrical power to the plurality of electronic speed controllers. The system includes supplying the control signals to the electronic speed controllers to enable a coordinated operation of the selective aerial movement and the surface mobility of the portable electronic device.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates a schematic diagram representation for a system for mobility of a portable electronic device using reversible wheel-propeller assemblies in accordance with an embodiment of the present disclosure;

FIG. 2 is a schematic diagram representation of a wheel propeller structure working in a vehicle mode of the system for mobility of a portable electronic device using reversible wheel-propeller assemblies of FIG. 1 in accordance with an embodiment of the present disclosure;

FIG. 3 is a schematic diagram representation of a wheel propeller structure working in a drone mode of the system for mobility of a portable electronic device using reversible wheel-propeller assemblies of FIG. 1 in accordance with an embodiment of the present disclosure;

FIG. 4 (a) is a flow chart representing steps involved in a method for mobility of a portable electronic device using reversible wheel-propeller assemblies in accordance with an embodiment of the present disclosure; and

FIG. 4 (b) illustrates continued steps of the method of FIG. 4 (a) in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiment of the present disclosure, a system for mobility of a portable electronic device using reversible wheel-propeller assemblies is disclosed. The system includes the portable electronic device including a control unit operatively coupled to a communication interface, wherein the control unit is configured to receive at least one of a user input and an external control data to generate a plurality of control signals. Additionally, the communication interface is configured to transmit the plurality of control signals in a form of a command data to actuate at least one or more operatively coupled components. The system includes a plurality of propellers integrated with the portable electronic device, wherein each of the plurality of propellers is adapted to rotationally actuate by a plurality of motors, wherein each of the plurality of motors is being disposed within a housing of the portable electronic device. Additionally, the plurality of propellers is adapted to generate a thrust upon controlled rotation, wherein the controlled rotation is being imparted by a corresponding motor to produce at least one of a lift and traction controlled rotation of the portable electronic device. The system includes a plurality of electronic speed controllers operatively coupled the plurality of motors, wherein each of the electronic speed controllers is configured to regulate at least one of a rotational speed and rotational direction of the corresponding motor in response to the control signals received from the portable electronic device. The system includes a detachable case releasably secured to the portable electronic device and a wireless communication receiver operatively coupled to the motor, wherein, the wireless communication receiver is configured to receive a command data via an electromagnetic coupling with a wireless communication transmitter of the portable electronic device. Additionally, the wireless communication receiver is configured to generate a motor control signal by processing a received command data and derive a control output for actuation of the motor. The system includes a plurality of visual indicators disposed on the detachable case and electrically coupled with the near-field communication receiver, wherein each of the visual indicator is configured to receive the motor control signals from the near-field communication receiver. Additionally, each of the visual indicator is configured to indicate an operational state of the system via a corresponding visual output, wherein the operational state comprises at least one of a flight initiation, landing indication, and power status. The system includes a plurality of attachment assemblies including a motor-driven wheel-propeller structure, wherein the wheel-propeller structure comprises a wheel body and an internal propeller blade assembly disposed within the wheel body, wherein the motor is adapted to rotate the internal propeller blade assembly in a first rotational direction to generate an airflow producing lift for an aerial movement and in a second rotational direction to generate a contact force for traction, thereby enabling a surface mobility of the portable electronic device. The system includes a movable arm structure coupled to the plurality of attachment assemblies, wherein the movable arm structure is adapted to displace the wheel-propeller structure to at least one of a raised position and a lowered ground-contact position in response to a rotation of the motor. The system also includes a power and a data interface operatively coupled to the portable electronic device and the plurality of attachment assemblies, wherein the power and the data interface is configured to deliver an electrical power to the plurality of electronic speed controllers. Additionally, the power and the data interface is configured to supply the control signals to the electronic speed controllers to enable a coordinated operation of the selective aerial movement and the surface mobility of the portable electronic device.

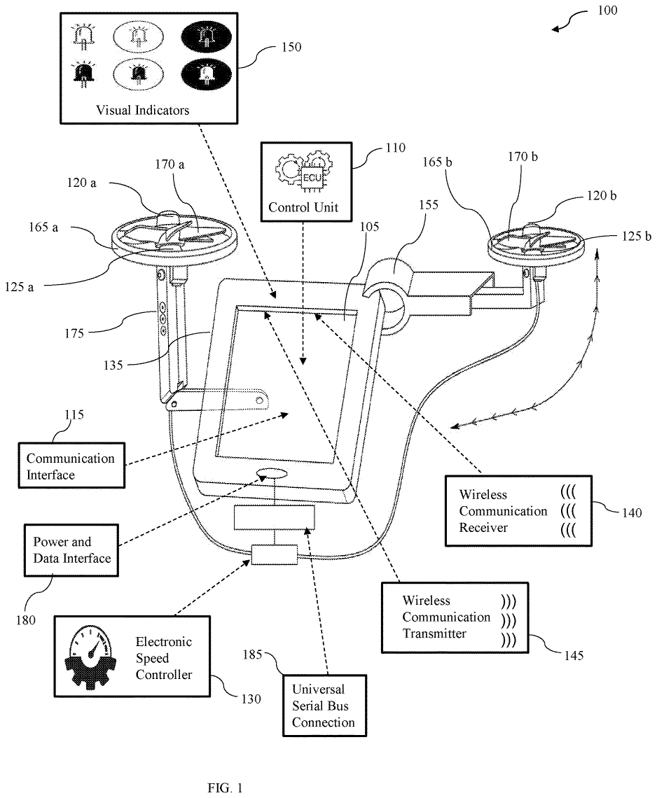

FIG. 1 illustrates a schematic diagram representation for a system for mobility of a portable electronic device using reversible wheel-propeller assemblies in accordance with an embodiment of the present disclosure. The system 100 includes the portable electronic device 105 comprising a control unit 110 operatively coupled to a communication interface 115, wherein the control unit 110 is configured to receive at least one of a user input and an external control data to generate a plurality of control signals. The portable electronic device 105 forms the primary platform for execution, wherein the device includes prevalent implementations such as smartphones, tablets, and wearable computing units, while remaining scalable to other compact computing systems with embedded processing capability. The portable electronic device 105 architecture supports integration with external actuation assemblies through standardized electrical and communication interfaces, thereby enabling extension beyond conventional static operation. Further, the control unit 110 operatively coupled to a communication interface 115 establishes a functional linkage between onboard computation and external data exchange layers. This arrangement allows the device 105 to operate as a central control node, leveraging existing hardware resources while maintaining adaptability across different form factors and deployment scenarios.

The control unit 110 functions as a computational core including at least one processor and associated memory configured to execute control computational logics and signal processing routines.

The communication interface 115 enables bidirectional data transfer using any of a wired or wireless protocols, facilitating reception of user input signals and external control data from auxiliary devices. The control unit 110 is configured to receive at least one of a user input and an external control data to generate a plurality of control signals through programmed logic, including signal mapping, timing control, and actuation sequencing. These generated control signals are structured for downstream transmission to actuator-driving components, thereby ensuring coordinated operation through deterministic control execution and real-time response characteristics.

The communication interface 115 is configured to transmit the plurality of control signals in a form of a command data to actuate at least one or more operatively coupled components. The communication interface 115 functions as a signal transmission layer operatively coupled to the control unit 110 to enable structured delivery of actuation commands to external components, wherein the interface may include at least one of a universal serial bus interface connection 185, near-field communication interface, or short-range wireless interface depending on deployment configuration. The communication interface 115 is configured to transmit the plurality of control signals in a form of command data by encoding processor-generated control logic into protocol-compliant data frames suitable for downstream interpretation. This includes at least one of a data serialization, signal conditioning, and timing synchronization to ensure reliable communication with components such as electronic speed controllers 130. The interface manages electrical characteristics including voltage levels and data integrity while supporting deterministic latency for real-time control.

In one embodiment, the communication interface 115 is configured to receive a remote control input from an external device via a wireless communication protocol, thereby converting the input into the control signals. The communication interface 115 is configured to receive a remote control input from an external device such as a smartwatch or secondary computing device via a wireless communication protocol including Bluetooth or near-field communication. The received input is captured as digital data packets and transferred to the control unit 110 for processing. The interface 115 performs protocol handling, signal decoding, and data validation to ensure accurate interpretation of the incoming commands. The control unit 110 then maps the decoded input into corresponding control parameters. These parameters are converted into structured control signals suitable for downstream components.

The system 100 includes a plurality of propellers 120 integrated with the portable electronic device 105, wherein each of the plurality of propellers 120 is adapted to rotationally actuate by a plurality of motors 125, wherein each of the plurality of motors 125 is being disposed within a housing of the portable electronic device 105. The plurality of propellers 120 a, 120 b integrated with the portable electronic device 105, wherein representative propellers 120 a, 120 b are shown while additional propellers may be arranged in a symmetric configuration to maintain dynamic balance and stability. Each propeller is positioned relative to the device 105 structure to enable distributed thrust generation, similar to multi-rotor configurations used in aerial platforms. The propellers 120 a, 120 b are adapted to generate aerodynamic lift through rotational airflow, with considerations of blade pitch, angular velocity, and thrust vector alignment. The symmetric deployment ensures uniform load distribution and minimizes vibration, thereby supporting stable operation under varying actuation conditions.

Each of the plurality of propellers 120 is adapted to rotationally actuate by a plurality of motors 125, wherein representative motors 125 a, 125 b are illustrated for clarity, while other motors may be arranged in corresponding symmetric configurations. Each of the plurality of motors 125 is being disposed within a housing of the portable electronic device 105, providing structural support, alignment, and protection for rotational components.

Additionally, each of the plurality of propellers 120 is adapted to generate a thrust upon controlled rotation, wherein the controlled rotation is being imparted by a corresponding motor 125 to produce at least one of a lift and traction controlled rotation of the portable electronic device 105. The motors 125 function by converting electrical energy into rotational mechanical output through electromagnetic interaction, driving the propellers 120 about their rotational axis. This arrangement ensures controlled torque delivery, efficient power transmission, and coordinated actuation across all propeller units for achieving the intended propulsion characteristics.

In one embodiment, the plurality of motors 125 are embedded within an internal structure of the portable electronic device 105 to form an integrated aerial propulsion configuration. The plurality of motors 125 are embedded within an internal structure of the portable electronic device 105 to form an integrated aerial propulsion configuration, wherein propulsion components are incorporated directly into the device 105 architecture rather than externally mounted. This configuration refers to a compact and structurally unified arrangement in which motors 125 are positioned within the device 105 housing to drive propeller 120 elements with minimal external protrusion. This enables an improved weight distribution, reduced aerodynamic drag, and optimized structural rigidity. The integration allows direct electrical and control coupling with the internal circuitry, thereby minimizing transmission losses and response latency. This is useful in the proposed system 100 by enabling an efficient lift generation while maintaining device 105 portability and mechanical stability.

The system 100 includes a plurality of electronic speed controllers 130 operatively coupled the plurality of motors 125, wherein each of the electronic speed controllers 130 is configured to regulate at least one of a rotational speed and rotational direction of the corresponding motor 125 in response to the control signals received from the portable electronic device 105. The plurality of electronic speed controllers 130 operatively coupled to the plurality of motors 125, wherein each electronic speed controller 130 may be implemented as a brushless direct current motor controller or equivalent motor drive circuit or any other suitable combination and option configured for precise actuation control. In the proposed system 100, the described functionality is achievable using a single electronic speed controller 130 configured to regulate operation of at least one motor 125 in accordance with received control signals. The architecture remains scalable, wherein a plurality of electronic speed controllers 130 can be deployed to independently control multiple motors for enhanced precision and distributed actuation. This flexibility enables adaptation from simplified configurations to multi-actuator implementations while maintaining the intended control functionality.

Each electronic speed controller 130 is configured to regulate at least one of a rotational speed and a rotational direction of the corresponding motor 125 by converting incoming command data into controlled electrical waveforms supplied to motor windings. This involves a pulse width modulation, phase commutation, and current regulation to achieve accurate torque and speed characteristics. In the proposed system 100, the electronic speed controllers 130 receive control signals from the portable electronic device 105 and translate them into synchronized drive signals for each motor 125. This enables coordinated multi-motor operation, directional control through bidirectional actuation, and real-time responsiveness.

The system 100 includes a detachable case 135 releasably secured to the portable electronic device 105 and a wireless communication receiver 140 operatively coupled to the motor 125, wherein the wireless communication receiver 140 is configured to receive a command data via an electromagnetic coupling with a wireless communication transmitter 145 of the portable electronic device 105. The detachable case 135 may be implemented as at least one of a protective enclosure, modular back cover, or clip-on housing adapted to integrate functional components without altering the base device architecture. Such arrangements include rigid polymer casings or composite enclosures that accommodate motors 125, controllers, and interface elements within a compact form factor. The use of the detachable case 135 enables modular deployment, thereby reducing manufacturing complexity and minimizing cost by leveraging existing device hardware. This structural arrangement simplifies system 100 realization by allowing add-on integration rather than permanent modification, while maintaining mechanical stability and alignment of embedded components. The approach supports ease of installation, replacement, and scalability across different device types, thereby ensuring that the invention can be implemented with minimal additional infrastructure and reduced economic overhead.

A communication architecture including the wireless communication transmitter 145 and the wireless communication receiver 140 enables transmission and reception of a command data through multiple short-range wireless communication protocols including but not limited to a bluetooth low energy, infrared communication, and radiofrequency based communication mechanisms. Accordingly, the communication architecture provides enhanced and optimized implementation, flexibility, and wider technological coverage without restricting operation to a specific communication standard.

In one embodiment, the detachable case 135 comprises a wireless power receiver configured to receive a power from a power electronic device and supply the power to the motors 125 via electronic speed controllers 130. The detachable case 135 comprises a wireless power receiver configured to receive power from a power electronic device through inductive or resonant coupling and to supply the received power to the motors 125 via the electronic speed controllers 130. The wireless power receiver converts the induced alternating field into regulated direct current suitable for motor actuation and control circuitry. The power is distributed through the electronic speed controllers 130, which condition the supply and drive the motors based on control signals. This arrangement enables cable-free operation while maintaining electrical isolation and compact integration within the case. Optionally, the system 100 is adaptable to wired power delivery through the power and data interface, providing flexibility based on application requirements. This ensures reliable energy transfer with efficient power management for sustained operation.

In continuation, the system 100 includes the wireless communication receiver 140 operatively associated with the motor 125, wherein the receiver 140 may be realized using short-range inductive communication module configured for low-power data acquisition. The wireless communication receiver 140 is adapted to receive command data through electromagnetic coupling, which refers to the transfer of energy and information via magnetic field interaction between closely positioned coils. The corresponding wireless communication transmitter 145, integrated within the portable electronic device 105, generates modulated electromagnetic fields encoding control instructions, which are then detected and decoded by the receiver 140. This enables wireless command transmission without direct electrical contact, thereby ensuring reliable and low-latency communication within short operational distances. The system 100 remains scalable to incorporate other comparable short-range communication techniques or inductive coupling mechanisms while preserving the intended functional behaviour of controlled motor actuation.

Additionally, the wireless communication receiver 140 is configured to generate a motor control signal by processing a received command data and derive a control output for actuation of the motor 125. The wireless communication receiver 140 is configured to generate a motor control signal by processing received command data through a decoding and signal conditioning stage, wherein the command data is wirelessly transmitted from the portable electronic device 105 acting as a primary control node within a layered control hierarchy. The received data may originate from user inputs, smartwatch gestures, thereby forming a multi-device synchronized control loop. Upon reception via electromagnetic coupling, the receiver 140 demodulates and interprets the encoded instructions and converts them into structured control parameters such as speed, direction, and actuation timing. These parameters are then translated into a control output compatible with a motor driving circuitry, thereby enabling precise actuation. This ensures low-latency and secure command execution within the detachable case architecture, while supporting scalable integration of multiple control interfaces. The arrangement facilitates coordinated operation across diverse input sources while maintaining deterministic control over the motor 125 for both aerial and ground-based functionalities.

In one embodiment, the wireless communication receiver 140 is configured to process the command data packets and generate a corresponding pulse width modulation signal for the electronic speed controllers 130. The wireless communication receiver 140 is configured to process received command data packets by decoding and mapping them into control parameters such as speed and direction. Based on these parameters, the receiver 140 generates a corresponding pulse width modulation signal suitable for driving the electronic speed controllers 130. The pulse width modulation signal varies duty cycle to regulate motor 125 speed and actuation precisely. This signal is transmitted to the electronic speed controllers 130, which use it to control motor operation.

The system includes a plurality of visual indicators 150 disposed on the detachable case 135 and electrically coupled with the wireless communication receiver 140, wherein each of the visual indicator 150 is configured to receive the motor control signals from the wireless communication receiver 140. The plurality of visual indicators 150 is disposed on the detachable case 135 to provide real-time operational feedback alternatively can be positioned elsewhere also, wherein the visual indicators 150 may include light-emitting diodes, micro display elements, or other low-power illumination components integrated within the case structure. These indicators 150 are electrically coupled with the wireless communication receiver 140 and positioned on an outer surface for clear visibility during operation. The visual indicators 150 form part of a layered control ecosystem, complementing inputs received from the portable electronic device 105, smartwatch, or auxiliary control interfaces. The indicators operate by receiving electrical signals corresponding to decoded command data, thereby enabling direct visualization of system states. This supports intuitive monitoring without requiring additional display hardware, thereby simplifying system 100 integration while maintaining low power consumption and compact design.

Additionally, each of the visual indicator 150 is configured to indicate an operational state of the system 100 via a corresponding visual output, wherein the operational state comprises at least one of a flight initiation, landing indication, and power status. Each of the visual indicator 150 is configured to indicate an operational state of the system 100 via a corresponding visual output, wherein the operational states include flight initiation, landing indication, and power status as representative conditions of system 100 behaviour. The flight initiation state may be represented by a distinct visual pattern indicating activation of propeller-driven lift and readiness for aerial operation, while a landing indication corresponds to a controlled reduction in actuation signalling transition toward ground engagement. The power status reflects availability or depletion of electrical energy, thereby enabling monitoring of operational continuity. These states are derived from motor control signals processed through the wireless communication receiver 140, thereby ensuring synchronization with actual actuation conditions. The indicators 150 translate control signal thresholds into predefined illumination responses, providing immediate visual feedback. This facilitates real-time awareness of system 100 mode within the detachable case 135 architecture and supports coordinated operation across the integrated control interfaces.

In one embodiment, the plurality of visual indicators 150 are configured to emit a plurality of colours corresponding to a predefined operational state. The plurality of visual indicators 150 are configured to emit a plurality of colours corresponding to predefined operational states to provide intuitive real-time feedback to the user. For example, a blue colour may indicate flight initiation or active aerial mode, while a yellow colour may represent landing or transition to ground mode. A green colour can denote normal operation or sufficient power availability, whereas a red colour may indicate low power or fault conditions requiring attention. Additional colours such as white or blinking patterns may be used to represent standby, pairing, or communication status. The colour mapping is derived from control signals processed within the system 100, ensuring synchronization with actual device 105 behaviour. This visual scheme enhances usability by enabling quick interpretation of system status without requiring additional interfaces.

In one embodiment, the present disclosure further contemplates that the plurality of visual indicators 150 may be implemented as an optional operational feature without limiting core functionality of the system. Such arrangement enables the system 100 to perform communication, control, and actuation functions independently of the visual indication mechanism while retaining compatibility with embodiments incorporating status visualization. Accordingly, the visual indicators 150 provide an optimized user interaction and operational monitoring flexibility without imposing a mandatory dependency on visual output generation.

Additionally, the system 100 includes a plurality of attachment assemblies 155 comprising a motor-driven wheel-propeller structure 160, wherein the wheel-propeller structure 160 comprises a wheel body 165 and an internal propeller blade assembly 170 disposed within the wheel body 165. The plurality of attachment assemblies 155 are utilized as a modular coupling structure adapted to be removably secured to the portable electronic device 105, wherein each attachment assembly 155 may include a compact clip, bracket, or integrated casing extension to support propulsion elements while maintaining structural stability. Such assemblies are designed to simplify mechanical integration by enabling standardized mounting without altering the base device, and may be arranged in symmetrical configurations to ensure balanced load distribution and operational stability. Each attachment assembly 155 comprises a motor-driven wheel-propeller structure 160, wherein the structure integrates rotational actuation and ground interface within a single unit. The motor-driven wheel-propeller structure 160 functions by receiving control inputs and converting electrical energy into rotational motion, thereby enabling combined propulsion and mobility. This modular approach allows scalable deployment of multiple assemblies, facilitating design flexibility and ease of manufacturing while preserving the intended functional performance of the system 100.

In one embodiment, the plurality of attachment assemblies 155 are adapted to detachably clamp onto a peripheral edge of the portable electronic device 105, thereby enabling a modular installation. The plurality of attachment assemblies 155 are adapted to detachably clamp onto a peripheral edge of the portable electronic device 105 through a mechanical gripping mechanism including but not limited to a spring-loaded jaws, elastic clips, or adjustable brackets. The clamping force is generated by resilient elements that apply inward pressure to securely hold the device 105 without permanent fastening. Contact surfaces may include friction-enhancing materials to prevent slippage and maintain alignment during operation. The assemblies 155 can alternatively be manually engaged and disengaged, allowing quick attachment and removal. This arrangement enables modular installation by supporting repeatable mounting without modifying the device 105 structure.

In one embodiment, the plurality of attachment assemblies 155 are arranged symmetrically around the portable electronic device 105 to provide a balanced thrust and a traction in course of the operation. Balanced thrust refers to an equal distribution of propulsion forces such that net moments are minimized, and the device 105 maintains stable orientation during operation. In the proposed system 100, it is achieved by arranging the plurality of attachment assemblies 155 symmetrically around the portable electronic device 105 so that opposing thrust vectors counteract unwanted tilting forces. During aerial operation, each motor-driven unit generates coordinated lift, while in ground mode, traction forces are evenly distributed across contact points. The control unit 110 further synchronizes motor 125 outputs to maintain uniform force generation.

The wheel-propeller structure 160 includes a wheel body 165 and an internal propeller blade assembly 170 disposed within the wheel body 165, wherein representative elements 165 a, 165 b and 170 a, 170 b denote symmetrical units positioned across the system 100 for balanced operation. The wheel body 165 is defined as an outer circumferential structure configured to interface with a ground surface, providing rolling support during surface mobility, while simultaneously enclosing the internal propeller blade assembly 170. The internal propeller blade assembly 170 is structured to rotate about a central axis to generate airflow, enabling lift generation for aerial operation. In operation, the motor 125 drives the internal propeller blades 170 within the wheel body 165, thereby producing thrust while the outer wheel structure maintains mechanical contact when required.

The motor 125 is adapted to rotate the internal propeller blade assembly 170 in a first rotational direction to generate an airflow producing lift for an aerial movement and in a second rotational direction to generate a contact force for traction, thereby enabling a surface mobility of the portable electronic device 105.

In a first rotational direction, the motor 125 drives the internal propeller blades 170 to push air downward, thereby generating an airflow that produces lift for aerial movement. This operation corresponds to a drone mode, wherein the device transitions from a static or ground state to a lifted condition through distributed thrust generation across multiple wheel-propeller structures 160. The control signals received through the communication interface 115 and processed via the wireless communication receiver 140 ensure synchronized actuation of all motors 125. The detachable case 135 architecture supports this operation by housing the components in a compact and aligned configuration. As a result, stable lift is achieved through coordinated rotation and aerodynamic force generation.

In a second rotational direction, the motor 125 reverses the rotation of the internal propeller blade assembly 170, altering the direction of airflow such that a downward force is applied through the wheel body 165 onto a supporting surface. This produces a contact force enabling traction, thereby allowing the system 100 to operate in a vehicle mode. In this mode, the wheel body 165 functions as a rolling interface while the internal blades 170 contribute to force generation assisting movement across the surface. This bidirectional actuation enables seamless transition between drone mode and vehicle mode using the same integrated structure. The symmetrical arrangement of assemblies ensures uniform traction and controlled movement, providing stability and efficient operation in both modes.

In one embodiment, the wheel body 165 comprises a hollow configuration accommodating the internal propeller blade assembly 170. The wheel body 165 includes a hollow configuration defined by an outer circumferential structure with an internal cavity sized to accommodate the internal propeller blade assembly 170. This hollow arrangement allows the propeller blades 170 to be positioned within the wheel 165 without increasing the external footprint of the structure. During operation, the motor 125 drives the internal blades 170 within the cavity, generating airflow through the open sections of the wheel body 165. The hollow design ensures unobstructed air passage while maintaining structural integrity for ground contact. It also enables combined functionality, allowing the wheel body 165 to act as both a rolling interface and a protective enclosure for the propeller assembly.

In one embodiment, the wheel-propeller structure 160 is further adapted to operate in a stationary airflow mode for generating a directed airflow with the detachable case 135 maintained in at least one of a handheld configuration and a stationary configuration. In the stationary airflow mode, the motor 125 actuates rotational movement of the wheel-propeller structure 160 without initiating aerial propulsion or ground traversal of the portable electronic device 105. The detachable case 135 is maintained in a handheld configuration or positioned on a support surface to direct airflow toward a surrounding area or a user. The wheel-propeller structure 160 thereby operates as an airflow generation mechanism for portable cooling functionality. Such configuration enables selective transition between mobility operation and stationary airflow operation using the same propulsion assembly.

Furthermore, the system 100 includes a movable arm structure 175 coupled to the plurality of attachment assemblies 155, wherein the movable arm structure 175 is adapted to displace the wheel-propeller structure 160 to at least one of a raised position and a lowered ground-contact position in response to a rotation of the motor 125. The movable arm structure 175 is coupled to the plurality of attachment assemblies 155 and extends outward to support the motor-driven wheel-propeller structures 160, wherein representative arms 175 a, 175 b are arranged symmetrically to maintain balanced displacement. The movable arm structure 175 is adapted to displace the wheel-propeller structure 160 to a raised position and to a lowered ground-contact position in response to rotation of the motor 125, thereby enabling a transition between aerial and surface operation. The arm may be formed from lightweight and high-strength materials such as reinforced polymers, aluminium alloys, or composite materials to provide stiffness with reduced mass. The movable nature is achieved through a pivoted linkage, hinge mechanism, or compliant flexural joint integrated at the coupling region with the attachment assembly. During operation, rotation of the motor 125 in a lift-generating direction produces an upward reaction force elevating the arm, while reverse rotation induces a downward force lowering the arm to ground-contact position. The structure 175 is engineered to withstand cyclic loading and maintain positional stability under dynamic conditions. The symmetrical arrangement ensures uniform actuation and balanced mechanical response across all supported wheel-propeller structures 160.

In one embodiment, the movable arm structure 175 comprises an L-shaped configuration 190 a, 190 b configured to convert a rotational force of the motor 125 into a vertical displacement of the wheel-propeller structure 160. The movable arm structure 175 comprises an L-shaped configuration 190 a, 190 b defined by two intersecting segments forming an angular linkage, which operates on a lever and moment-arm principle to translate rotational force into linear displacement. In this arrangement, the rotation of the motor 125 generates a torque that produces a moment about a pivot point of the L-shaped arm. This moment causes one segment of the arm to rotate, thereby converting the rotational input into a vertical displacement of the wheel-propeller structure 160. The geometry of the L-shape provides mechanical advantage and controlled motion transfer, enabling efficient lifting or lowering with minimal energy loss. This allows a precise positioning of the wheel-propeller structure 160 between raised and ground-contact states. The design optimizes stability, compactness, and responsiveness of the actuation mechanism. It also simplifies mechanical integration by combining motion conversion and support within a single structural element.

In one embodiment, the movable arm structure 175 comprises at least one magnetic locking element coupled with the L-shaped configuration 190 a, 190 b and configured to magnetically lock the movable arm structure in at least one of a drone mode position, a vehicle mode position, and a detachable case docking position, thereby enabling controlled snapping during mode transition. The movable arm structure 175 incorporates the magnetic locking element along the L-shaped configuration 190 a, 190 b to facilitate arm locking during positional transition of the wheel-propeller structure 160. The magnetic interaction enables controlled snapping between drone mode and vehicle mode by maintaining the movable arm structure 175 in a predefined operational position after displacement. Further, the magnetic coupling assists in stabilizing the arm structure relative to the detachable case during docking and deployment operations. Such arrangement reduces unintended positional movement, improves transition precision, and enables repeatable engagement and disengagement of the movable arm structure during mode conversion operations.

Moreover, the system 100 includes a power and a data interface 180 operatively coupled to the portable electronic device 105 and the plurality of attachment assemblies 155, wherein the power and the data interface 180 is configured to deliver an electrical power to the plurality of electronic speed controllers 130. The system 100 includes the power and data interface 180 operatively coupled to the portable electronic device 105 and the plurality of attachment assemblies 155, wherein the interface 180 is configured as a combined electrical and signal transfer pathway enabling coordinated operation of distributed components. The power and data interface 180 may include implementations such as a universal serial bus connection 185, multi-pin docking connector, flexible printed circuit linkage, or equivalent conductive pathways integrated within a detachable case architecture. This interface 180 establishes both electrical continuity for power delivery and a communication channel for control signals between the device and downstream elements. Additionally, the interface 180 supports modular integration by allowing the attachment assemblies 155 to receive required input without independent power sources. This reduces system 100 complexity and enables a compact and scalable design adaptable to different configurations.

In one embodiment, the power and the data interface 180 includes the universal serial bus 185 connection configured to transmit a multi-bit control data to the electronic speed controllers 130. The universal serial bus 185 connection is a standardized wired interface that enables both power delivery and serial data communication between the portable electronic device 105 and external components. The universal serial bus 185 connection is configured to transmit multi-bit control data by encoding control signals into serial data packets and forwarding them through the interface 185. The transmitted data is received and interpreted by downstream circuitry associated with the electronic speed controllers 130. This allows distribution of distinct control instructions to multiple controllers using a structured data format.

In one embodiment, the multi-bit control data comprises a plurality of discrete control bits individually mapped to corresponding electronic speed controllers 130 associated with respective wheel-propeller structure 160 for independent propulsion control. The system 100 further comprises a bit-mapped propulsion control configuration in which communication data received through the universal serial bus connection 185 is converted into a plurality of discrete binary control outputs via a USB-to-transistor-transistor-logic conversion arrangement. In an exemplary 4-bit configuration, a first bit is mapped to a front-left wheel-propeller structure, a second bit is mapped to a front-right wheel-propeller structure, a third bit is mapped to a rear-left wheel-propeller structure, and a fourth bit is mapped to a rear-right wheel-propeller structure. Each binary control bit independently actuates a corresponding electronic speed controller 130 to selectively control rotational operation of an associated wheel-propeller structure. Such discrete bit-to-motor mapping enables synchronized propulsion coordination, directional manoeuvre execution, and compact transmission of propulsion control data during ground and aerial operation modes.

The power and data interface 180 is configured to deliver electrical power to the plurality of electronic speed controllers 130 while simultaneously enabling transmission of control signals originating from the control unit 110. The electrical power supplied through the interface is regulated and distributed to each electronic speed controller 130, which in turn drives the corresponding motors 125 based on received commands. This includes current distribution, voltage regulation, and signal integrity management to ensure stable operation under varying load conditions. The interface 180 also facilitates synchronization by maintaining consistent timing between power delivery and data transmission. This integrated operation enables efficient energy utilization and coordinated actuation across all attachment assemblies. As a result, the system achieves reliable performance with centralized control and minimal external circuitry.

The power and data interface 180 is also configured to supply the control signals to the electronic speed controllers 130 to enable a coordinated operation of the selective aerial movement and the surface mobility of the portable electronic device 105. The interface 180 conditions and routes the control data in synchronized timing with power delivery to ensure reliable signal integrity. Each electronic speed controller 130 receives the control signals and translates them into motor 125 actuation commands. This enables coordinated control of motor speed and direction across all attachment assemblies. As a result, the system 100 achieves synchronized aerial movement and surface mobility of the portable electronic device 105.

In one embodiment, the portable electronic device 105 is configured to execute a control application adapted to adjust the motor 125 speed and direction to selectively enable at least one of a handheld mode, a ground mobility mode, and an aerial flight mode. The portable electronic device 105 is configured to execute a control application that adjusts motor 125 speed and direction to enable multiple operational modes based on user input and control logic. In a handheld mode, the motors 125 are inactive or maintained at minimal output, allowing the device 105 to function as a standard portable unit without propulsion. In a ground mobility mode, the motors 125 are driven in a direction that generates traction through the wheel body 165, enabling rolling movement across a surface. In an aerial flight mode, the motors 125 rotate in a direction that drives the internal propeller blades 170 to generate lift for airborne operation. The control application implements these modes by mapping input commands to predefined motor control parameters and switching between them dynamically. This ensures seamless transition between modes while maintaining coordinated actuation across all motor units.

In one embodiment, the portable electronic device 105 further comprises a sensor interface configured to process an inertial measurement data and adjust the control signals for stabilizing the aerial movement. The portable electronic device 105 may optionally comprise a sensor interface configured to acquire and process inertial measurement data from sensors such as accelerometers and gyroscopes. The sensor interface performs signal conditioning and fusion of orientation and motion data to determine real-time device attitude. Based on this processed data, the control unit 110 dynamically adjusts the control signals supplied to the motors 125 to correct deviations. This feedback mechanism enables stabilization during aerial movement by compensating for disturbances. The inclusion of the sensor interface enhances control accuracy while remaining an optional feature within the system 100 architecture.

In one embodiment, the portable electronic device 105 is configured to transmit live video data to a remote device in course of an operation to enable a real-time monitoring and control. The portable electronic device 105 is configured to transmit live video data by capturing visual input through an integrated camera and encoding it into a compressed digital stream suitable for wireless transmission. The encoded video data is processed in real time by the control unit 110 and routed through the communication interface 115 using protocols such as wireless local area network or cellular communication. The transmission is maintained with low latency to ensure continuous streaming to a remote device. The remote device receives and decodes the stream to provide real-time visual feedback for monitoring and control. This enables the user to observe operational conditions and issue responsive control inputs during aerial or surface operation.

In one embodiment, the system includes an optional periscope clip camera configured to capture the visual data from an altered viewing angle relative to a native camera orientation of the portable electronic device 105. The optional periscope clip camera is selectively position able relative to the portable electronic device 105 to extend a visual field beyond the native camera orientation. The periscope arrangement redirects an image capture path to enable acquisition of visual data from obstructed, elevated, or angular regions. Such flexible positioning configuration improves environmental visibility and enhances operational monitoring during navigation and manoeuvring operations.

In one embodiment, the system 100 is further configured to autonomously transition between a ground mobility mode and an aerial mobility mode based on at least one detected operational condition. The optional autonomous operational configuration enables independent transition of the system 100 between the ground mobility mode and the aerial mobility mode based on detected operational conditions without continuous user intervention. The operational conditions are identified from at least one of an acquired environmental data, movement parameters, navigation states, or obstacle conditions. Upon detection of a predefined operational condition, the system 100 selectively actuates the wheel-propeller structure 160 and the movable arm structure 175 to perform a corresponding mobility transition.. Such arrangement enables adaptive operation and intelligent manoeuvre execution during navigation and traversal operations.

The techniques described in this disclosure may be implemented, at least in part, in hardware, software, firmware, or any combination thereof. For example, various aspects of the described techniques may be implemented within one or more processors in the control unit 110 including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry.

In another embodiment, the drawings illustrated in FIG. 1 are exemplary in nature and are provided for representative understanding of the system 100 components. The components are indicated using arrow marks to depict relative positioning and functional association. The illustrated arrangement is not intended to limit the exact structural placement or orientation of the components. During implementation, the positioning and configuration may be varied as per design requirements without departing from the scope of the invention.

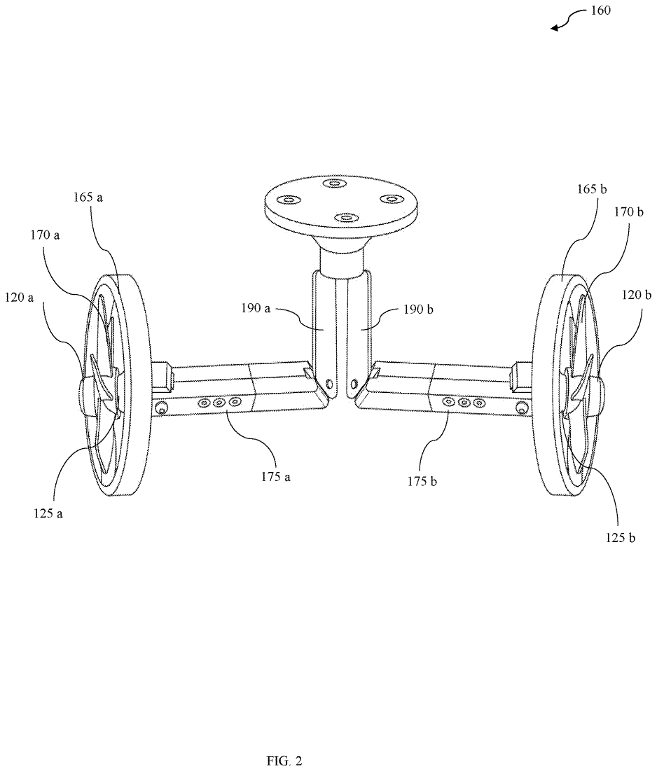

FIG. 2 is a schematic diagram representation of a wheel propeller structure working in a vehicle mode of the system for mobility of a portable electronic device using reversible wheel-propeller assemblies of FIG. 1 in accordance with an embodiment of the present disclosure. In vehicle mode, the motors 125 are actuated in a rotational direction configured to generate traction through the wheel body 165 in contact with a surface. The wheel-propeller structures 160 function as rolling elements to enable controlled ground movement. The movable arm structure 175 maintains the assemblies in a lowered ground-contact position for stability. Coordinated motor 125 control ensures directional mobility and balanced traction across the system 100.

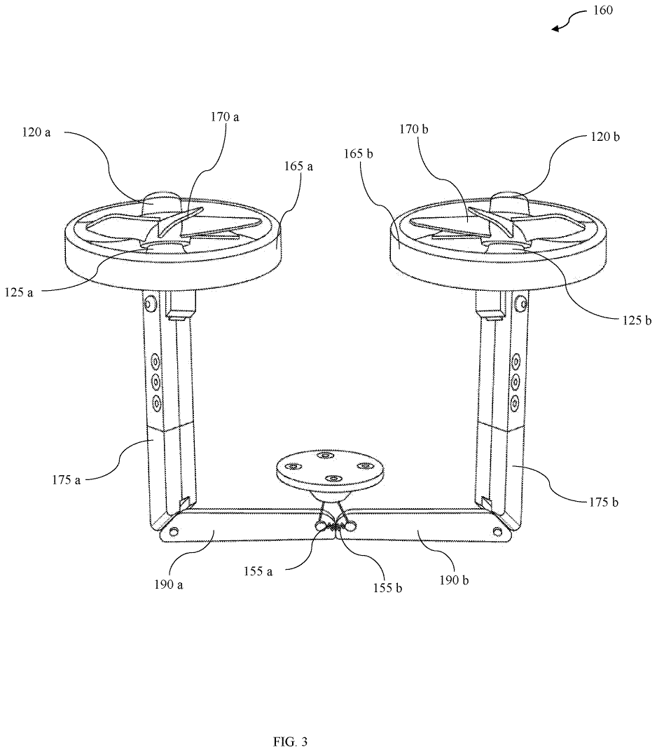

FIG. 3 is a schematic diagram representation of a wheel propeller structure working in a drone mode of the system for mobility of a portable electronic device using reversible wheel-propeller assemblies of FIG. 1 in accordance with an embodiment of the present disclosure. In drone mode, the motors 125 are actuated in a rotational direction configured to generate lift through airflow produced by the internal propeller blade assembly 170, wherein the wheel-propeller structure 160 operate as propulsion units to elevate the device 105 for aerial movement, the movable arm structure 175 displaces the assemblies to a raised position to facilitate unobstructed airflow, and synchronized motor actuation enables stable lift, controlled navigation, and balanced thrust during flight.

In a non-limiting example, consider a scenario, a user deploys the system 100 during an outdoor inspection task where the portable electronic device 105 is required to access both ground-level and elevated viewpoints. Initially, the device 105 operates in a handheld mode while the control unit 110 receives user input through an application interface. Upon reaching a restricted area, the user activates mobility mode, wherein the communication interface 115 transmits command data to the electronic speed controllers 130 to drive the motors 125 in a direction generating traction, enabling the device 105 to move across uneven terrain using the wheel-propeller structures 160. As the terrain becomes inaccessible, the user switches to aerial mode, causing the motors 120 to reverse rotation and generate lift through the internal propeller blade assemblies 170, while the movable arm structure 175 raise the assemblies for unobstructed airflow. The detachable 135 case facilitates seamless integration of propulsion components without altering the device 105, while the wireless communication receiver 140 processes command data transmitted via electromagnetic coupling from the device 105 to ensure synchronized actuation. During operation, visual indicators 150 provide real-time feedback such as flight initiation and power status, assisting the user in monitoring system conditions. The power and data interface 180 continuously supplies electrical power and control signals to maintain coordinated motor performance. Additionally, the device 100 streams live video to a remote terminal, enabling real-time monitoring and control adjustments. The system 100 allows the user to navigate confined spaces, elevate for aerial inspection, and return to ground mobility seamlessly. This integrated operation demonstrates efficient transition between modes while maintaining stability through symmetrical thrust distribution. The modular attachment assemblies allow quick installation and removal, making the system 100 adaptable across different use cases. The combination of wireless control, reversible actuation, and integrated propulsion enables practical deployment in surveillance, inspection, and remote navigation tasks.

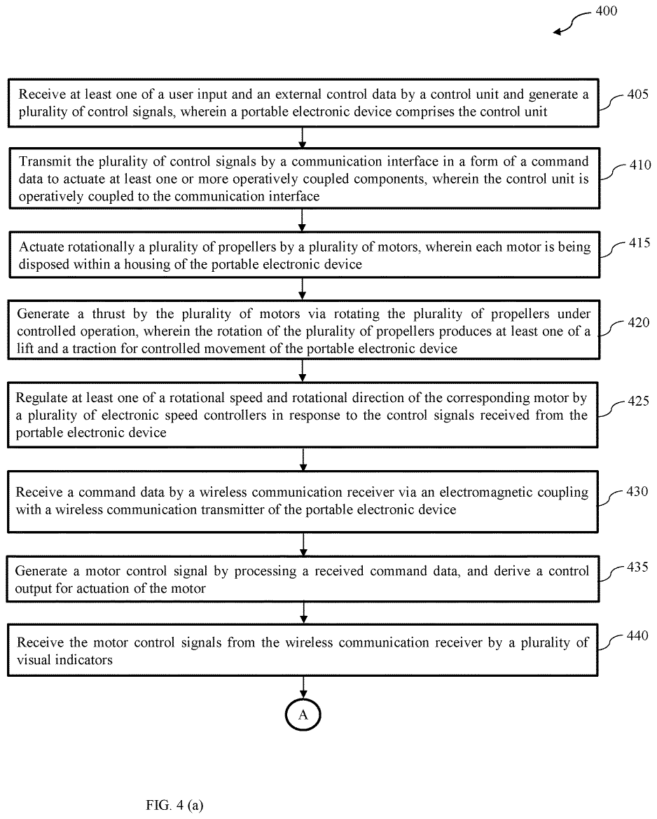

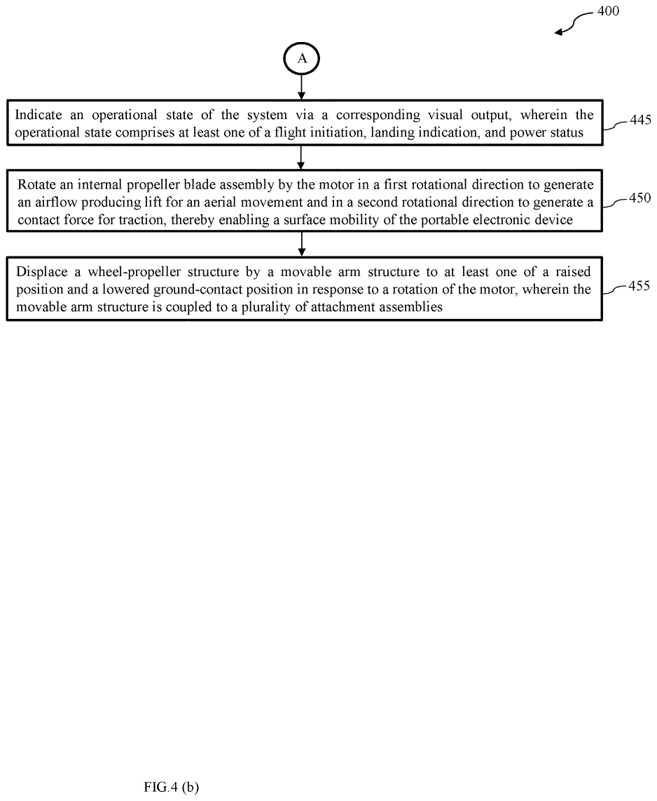

FIG. 4 (a) is a flow chart representing steps involved in a method for mobility of a portable electronic device using reversible wheel-propeller assemblies in accordance with an embodiment of the present disclosure. FIG. 4 (b) illustrates continued steps of the method of FIG. 4 (a) in accordance with an embodiment of the present disclosure. The method 400 begins at step 405.

The method 400 includes receiving, by a control unit, at least one of a user input and an external control data and generate a plurality of control signals, wherein a portable electronic device comprises the control unit in the step 405.

The method 400 includes transmitting, by a communication interface, the plurality of control signals in a form of a command data to actuate at least one or more operatively coupled components, wherein the control unit is operatively coupled to the communication interface in the step 410.

The method 400 includes actuating rotationally, by a plurality of motors, a plurality of propellers, wherein each motor is being disposed within a housing of the portable electronic device in the step 415.

The method 400 includes generating, by the plurality of motors, a thrust by rotating the plurality of propellers under controlled operation, wherein the rotation of the plurality of propellers produces at least one of a lift and a traction for controlled movement of the portable electronic device in the step 420.

The method 400 includes regulating, by a plurality of electronic speed controllers, at least one of a rotational speed and rotational direction of the corresponding motor in response to the control signals received from the portable electronic device in the step 425.

The method 400 includes receiving, by a near-field communication receiver, a command data via an electromagnetic coupling with a wireless communication transmitter of the portable electronic device in the step 430.

The method 400 includes generating, by processing a received command data, a motor control signal and derive a control output for actuation of the motor in the step 435.

The method 400 includes receiving, by a plurality of visual indicators, the motor control signals from the wireless communication receiver in the step 440.

The method 400 includes indicating, via a corresponding visual output, an operational state of the system, wherein the operational state comprises at least one of a flight initiation, landing indication, and power status in the step 445.

The method 400 includes rotating, by the motor, an internal propeller blade assembly in a first rotational direction to generate an airflow producing lift for an aerial movement and in a second rotational direction to generate a contact force for traction, thereby enabling a surface mobility of the portable electronic device in the step 450.

The method 400 includes displacing, by a movable arm structure, a wheel-propeller structure to at least one of a raised position and a lowered ground-contact position in response to a rotation of the motor, wherein the movable arm structure is coupled to a plurality of attachment assemblies in the step 455.

In one embodiment, the method 400 includes delivering, by a power and a data interface, an electrical power to the plurality of electronic speed controllers.

In another embodiment, the method 400 includes supplying, by the power and the data interface, the control signals to the electronic speed controllers to enable a coordinated operation of the selective aerial movement and the surface mobility of the portable electronic device.

The method 400 ends at step 455.

Various embodiments of the system and method for mobility of a portable electronic device using reversible wheel-propeller assemblies described above enables various advantages. The invention provides a unified mobility platform by integrating aerial propulsion and ground traction within a single portable electronic device 105, eliminating the need for separate drone and ground vehicle systems. The use of reversible wheel-propeller assemblies enables seamless transition between surface mobility and aerial movement, enhancing operational flexibility in constrained environments. Integration of motors 125 within the device 105 housing and the detachable case 135 architecture reduces structural complexity and avoids permanent modification of the base device. The near-field communication based command transfer ensures low-latency and reliable control without extensive wiring, improving system responsiveness. The inclusion of electronic speed controllers 130 enables precise regulation of motor speed and direction, resulting in stable thrust and controlled navigation. The L-shaped movable arm structure 175 provides an efficient mechanical advantage by converting rotational motion into vertical displacement, enabling reliable transition between operational modes. Symmetrical arrangement of attachment assemblies 155 ensures balanced force distribution, minimizing vibration and improving stability during operation. The power and data interface 180 supports centralized energy distribution and synchronized control, reducing dependency on multiple power sources. Visual indicators 150 provide immediate operational feedback, enhancing user awareness without additional interfaces. The system 100 supports modular installation, allowing easy attachment and removal across compatible devices. Real-time video transmission capability enables remote monitoring and control, extending usability in surveillance and inspection tasks. Overall, the invention delivers a cost-effective, scalable, and multifunctional mobility solution that overcomes limitations of existing single-mode system.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I/We claim:

1. A system for mobility of a portable electronic device using reversible wheel-propeller assemblies comprising:
the portable electronic device comprising a control unit operatively coupled to a communication interface, wherein the control unit is configured to receive at least one of a user input and an external control data to generate a plurality of control signals,
wherein the communication interface is configured to transmit the plurality of control signals in a form of a command data to actuate at least one or more operatively coupled components;
a plurality of propellers integrated with the portable electronic device, wherein each of the plurality of propellers is adapted to:
rotationally actuate by a plurality of motors, wherein each of the plurality of motors is being disposed within a housing of the portable electronic device; and
generate a thrust upon controlled rotation, wherein the controlled rotation is being imparted by a corresponding motor to produce at least one of a lift and traction controlled rotation of the portable electronic device;
a plurality of electronic speed controllers operatively coupled the plurality of motors, wherein each of the electronic speed controllers is configured to regulate at least one of a rotational speed and rotational direction of the corresponding motor in response to the control signals received from the portable electronic device;
a detachable case releasably secured to the portable electronic device and a wireless communication receiver operatively coupled to the motor, wherein the wireless communication receiver is configured to:
receive a command data via an electromagnetic coupling with a wireless communication transmitter of the portable electronic device; and
generate a motor control signal by processing a received command data and derive a control output for actuation of the motor;
a plurality of visual indicators disposed on the detachable case and electrically coupled with the near-field communication receiver, wherein each of the visual indicator is configured to:
receive the motor control signals from the near-field communication receiver; and
indicate an operational state of the system via a corresponding visual output, wherein the operational state comprises at least one of a flight initiation, landing indication, and power status;
a plurality of attachment assemblies comprising a motor-driven wheel-propeller structure, wherein the wheel-propeller structure comprises a wheel body and an internal propeller blade assembly disposed within the wheel body, wherein the motor is adapted to:
rotate the internal propeller blade assembly in a first rotational direction to generate an airflow producing lift for an aerial movement and in a second rotational direction to generate a contact force for traction, thereby enabling a surface mobility of the portable electronic device;
a movable arm structure coupled to the plurality of attachment assemblies, wherein the movable arm structure is adapted to displace the wheel-propeller structure to at least one of a raised position and a lowered ground-contact position in response to a rotation of the motor.

2. The system of claim 1, wherein the communication interface is configured to receive a remote control input from an external device via a wireless communication protocol, thereby converting the input into the control signals.

3. The system of claim 1, further comprising:
a power and a data interface operatively coupled to the portable electronic device and the plurality of attachment assemblies, wherein the power and the data interface is configured to:
deliver an electrical power to the plurality of electronic speed controllers; and
supply the control signals to the electronic speed controllers to enable a coordinated operation of the selective aerial movement and the surface mobility of the portable electronic device.

4. The system of claim 1, wherein the plurality of visual indicators are selectively operable and optionally enabled for providing the corresponding visual output associated with the operational state of the system.

5. The system of claim 1, wherein the plurality of motors are embedded within an internal structure of the portable electronic device to form an integrated aerial propulsion configuration.

6. The system of claim 1, wherein the detachable case comprises a wireless power receiver configured to receive a power from the power electronic device and supply the power to the motors via electronic speed controllers.

7. The system of claim 1, wherein the plurality of visual indicators are configured to emit a plurality of colours corresponding to a predefined operational state.

8. The system of claim 1, wherein the wheel body of the wheel-propeller structure comprises a hollow configuration accommodating the internal propeller blade assembly.

9. The system of claim 1, wherein the movable arm structure comprises:
an L-shaped configuration configured to convert a rotational force of the motor into a vertical displacement of the wheel-propeller structure; and
at least one magnetic locking element coupled with the L-shaped configuration and configured to magnetically lock the movable arm structure in at least one of a drone mode position, a vehicle mode position, and a detachable case docking position, thereby enabling a controlled snapping in course of mode transition.

10. The system of claim 1, wherein the wheel-propeller structure is further adapted to operate in a stationary airflow mode for generating a directed airflow with the detachable case maintained in at least one of a handheld configuration and a stationary configuration.

11. The system of claim 1, further comprising an periscope clip camera configured to capture a visual data from an altered viewing angle relative to a native camera orientation of the portable electronic device.

12. The system of claim 1, further comprising an autonomous operational configuration configured to transition the system between a ground mobility mode and an aerial mobility mode based on at least one detected operational condition.

13. The system of claim 1, wherein the portable electronic device is configured to execute a control application adapted to adjust the motor speed and direction to selectively enable at least one of a handheld mode, a ground mobility mode, and an aerial flight mode.

14. The system of claim 1, wherein the wireless communication receiver is configured to process the command data packets and generate a corresponding pulse width modulation signal for the electronic speed controllers.

15. The system of claim 1, wherein the plurality of attachment assemblies are adapted to detachably clamp onto a peripheral edge of the portable electronic device, thereby enabling a modular installation.

16. The system of claim 1, wherein the portable electronic device further comprises a sensor interface configured to process an inertial measurement data and adjust the control signals for stabilizing the aerial movement.

17. The system of claim 1, wherein the portable electronic device is configured to transmit live video data to a remote device in course of an operation to enable a real-time monitoring and control.

18. The system of claim 1, wherein the plurality of attachment assemblies are arranged symmetrically around the portable electronic device to provide a balanced thrust and a traction in course of the operation.

19. A method for mobility of a portable electronic device using reversible wheel-propeller assemblies comprising:
receiving, by a control unit, at least one of a user input and an external control data and generate a plurality of control signals, wherein a portable electronic device comprises the control unit;
transmitting, by a communication interface, the plurality of control signals in a form of a command data to actuate at least one or more operatively coupled components, wherein the control unit is operatively coupled to the communication interface;
actuating rotationally, by a plurality of motors, a plurality of propellers, wherein each motor is being disposed within a housing of the portable electronic device;
generating, by the plurality of motors, a thrust by rotating the plurality of propellers under controlled operation, wherein the rotation of the plurality of propellers produces at least one of a lift and a traction for controlled movement of the portable electronic device;
regulating, by a plurality of electronic speed controllers, at least one of a rotational speed and rotational direction of the corresponding motor in response to the control signals received from the portable electronic device;
receiving, by a near-field communication receiver, a command data via an electromagnetic coupling with a wireless communication transmitter of the portable electronic device;
generating, by processing a received command data, a motor control signal and derive a control output for actuation of the motor;
receiving, by a plurality of visual indicators, the motor control signals from the near-field communication receiver;
indicating, via a corresponding visual output, an operational state of the system, wherein the operational state comprises at least one of a flight initiation, landing indication, and power status;
rotating, by the motor, an internal propeller blade assembly in a first rotational direction to generate an airflow producing lift for an aerial movement and in a second rotational direction to generate a contact force for traction, thereby enabling a surface mobility of the portable electronic device; and
displacing, by a movable arm structure, a wheel-propeller structure to at least one of a raised position and a lowered ground-contact position in response to a rotation of the motor, wherein the movable arm structure is coupled to a plurality of attachment assemblies.

20. A non-transitory computer-readable medium storing a computer program that, when executed by a processor, causes the processor to perform a method for mobility of a portable electronic device using reversible wheel-propeller assemblies comprising:
receiving at least one of a user input and an external control data and generate a plurality of control signals;
transmitting the plurality of control signals in a form of a command data to actuate at least one or more operatively coupled components;
regulating at least one of a rotational speed and rotational direction of the corresponding motor in response to the control signals received from a portable electronic device;
receiving a command data via an electromagnetic coupling with a wireless communication transmitter of the portable electronic device;
generating a motor control signal and derive a control output for actuation of the motor;
receiving the motor control signals from a near-field communication receiver;
indicating an operational state of the system, wherein the operational state comprises at least one of a flight initiation, landing indication, and power status;
delivering an electrical power to the plurality of electronic speed controllers; and
supplying the control signals to the electronic speed controllers to enable a coordinated operation of the selective aerial movement and the surface mobility of the portable electronic device.
